(19) United States
(12) Patent Application Publication
(10) Pub. No.: US 2007/0208806 A1
(43) Pub. Date: Sep. 6, 2007

(54) Network collaboration system with conference waiting room

(75) Inventors: Nicole Y. Mordecai, Weston, MA (US); Michael Wessler, Westwood, MA (US); Jonathan H. Kaplan, Cambridge, MA (US); Joseph E. Provino, Arlington, MA (US); Karl Haberl, Tyngsboro, MA (US)

Correspondence Address: RISSMAN JOBSE HENDRICKS & OLIVERIO, LLP, ONE STATE STREET, SUITE 800, BOSTON, MA, 02109, US

(73) Assignee: Sun Microsystems, Inc., Santa Clara, CA (US)

(21) Appl. No.: 11/367,845

(22) Filed: Mar. 2, 2006

(51) Int. Cl. G06F 15/16; G06F 17/00; G06F 3/00

(52) U.S. Cl. 709/204; 715/753

(57) ABSTRACT

A network collaboration system facilitates collaborations between network clients having access to a digital network. The system uses audio mixes to provide different levels of voice conferences between the meeting participants. When a virtual meeting space is created, each meeting participant is given certain access privileges. In a main collaboration, those participating in the main collaboration receive an audio output that includes audio inputs from the other participants. A separate group of participants may be sequestered in a waiting room, unable to receive audio inputs from participants in the main collaboration. Certain participants in the main collaboration have the ability to grant access to the waiting room participants to join the main meeting, depending on the access privileges of the participant granting access. Main collaboration participants may also exit the main collaboration and enter the waiting room.

### FIELD OF THE INVENTION

This invention is directed, generally, to the field of collaboration software systems for use on a digital network and, more specifically, to voice communications on such systems.

### BACKGROUND OF THE INVENTION

With the rise of networked computing systems, particularly in business settings, new tools have emerged that allow network users, or clients, to interact with one another in various ways. Email, for example is a ubiquitous communication means which allows text messages to be communicated selectively over a network. Similarly, instant messaging and text-based “chats” have proven popular tools for communicating textual information between network clients. More recently, audio communication has been used over digital networks, the best-known format being the “voice-over-internet protocol” (VOIP). Even video conferencing has been used over digital networks, to varying degrees of success.

Collaboration software, sometimes referred to as “groupware” is designed to allow multiple network users to work on a single project together from separate workstations. One version of such software is “NOTES” which is a registered trademark and product of Lotus Development Corporation, Cambridge, Mass. Another is “NETMEETING” which is a registered trademark and product of Microsoft Corporation, Redmond, Wash. The goal of these products is to allow conferencing between multiple network clients, and collaboration among those clients in which they interact to manipulate a target such as a document or “whiteboard.” However, while improvements have been made in these products, there are areas in which the ability of users to communicate or collaborate may be improved.

### SUMMARY OF THE INVENTION

In accordance with the present invention a network collaboration system is provided that facilitates interaction between network clients having access to a digital network. The system makes use of an audio communications tool that accepts inputs from each of the network clients, and provides audio outputs to network clients that are made up of a mix of the audio inputs. A network interface is also provided that allows the network clients to participate in a collaboration in which certain collaborating clients are connected using the audio communications tool. That is, audio inputs from the participants are mixed together and delivered to the participants as audio outputs. This allows for voice conferences to be held between the participants represented by the network clients.

The system also includes a grouping feature by which participants in a collaboration are segregated into a plurality of groups. A first group of the clients are in audio communication with each other in a primary audio forum. This primary forum may be viewed as the “main meeting” via which the desired collaboration takes place. It may, however, be desirable to temporarily exclude certain participants from the primary forum due, for example, to the exchange of sensitive information. This second group of participants are therefore sequestered in a virtual space, which may be thought of as a “waiting room,” and receive no audio inputs from participants in the first group. An access tool may then be used by at least one participant in the first group to identify the participants in each of the first and second groups and to selectively grant access to any designated participants of the second group that allows the designated participants to join the first group.

The network interface may include a meeting creation tool that allows a network client to create a virtual meeting space by which the participants to a collaboration are selected. Each of the participants has a set of access privileges, and those access privileges may be set by the network client that creates the virtual meeting space. The meeting creator may also grant privileges to one or more other participants that allow them to change the privileges of other participants. The access privileges may be used to establish the ability of a participant to join the first group. The access privileges may also be used to establish the ability of a participant to grant access to participants of the second group that allows them to join the first group. This might be viewed as the ability to “invite” second group participants to join the main meeting in the first group. The system may also include an “exit” function that allows participants of the first group to exit the first group and join the second group. The ability of such a participant to rejoin the first group after exiting it depends on the access privileges of that participant. A “visit” function may also be included that allows any participant of the first group to temporarily join the second group and return to the first group regardless of that participant's access privileges.

### BRIEF DESCRIPTION OF THE DRAWINGS

The above and further advantages of the invention may be better understood by referring to the following description in conjunction with the accompanying drawings in which:

FIG. 1 is a graphical depiction of a network collaboration system environment typical of the present invention;

FIG. 2 is a graphical view of the components of a collaboration tool according to the present invention;

FIG. 3 is a depiction of a display window of a console that may be used with the collaboration tool of FIG. 2;

FIG. 4 is a depiction of a display window of a meeting creation function of a collaboration tool like that shown in FIG. 2;

FIG. 5 is a depiction of a display window for a facilitator of a collaboration tool like that shown in FIG. 2;

FIG. 6 is a depiction of the facilitator window of FIG. 5, with certain functions enabled;

FIG. 7 is a depiction of the facilitator window of FIG. 5 with an adjacent waiting room window;

FIG. 8 is a depiction of the facilitator window and waiting room window of FIG. 7, where a member of the main meeting is visiting the waiting room; and

FIG. 9 is a depiction of the facilitator window of FIG. 5 with multiple adjacent waiting room windows.

### DETAILED DESCRIPTION

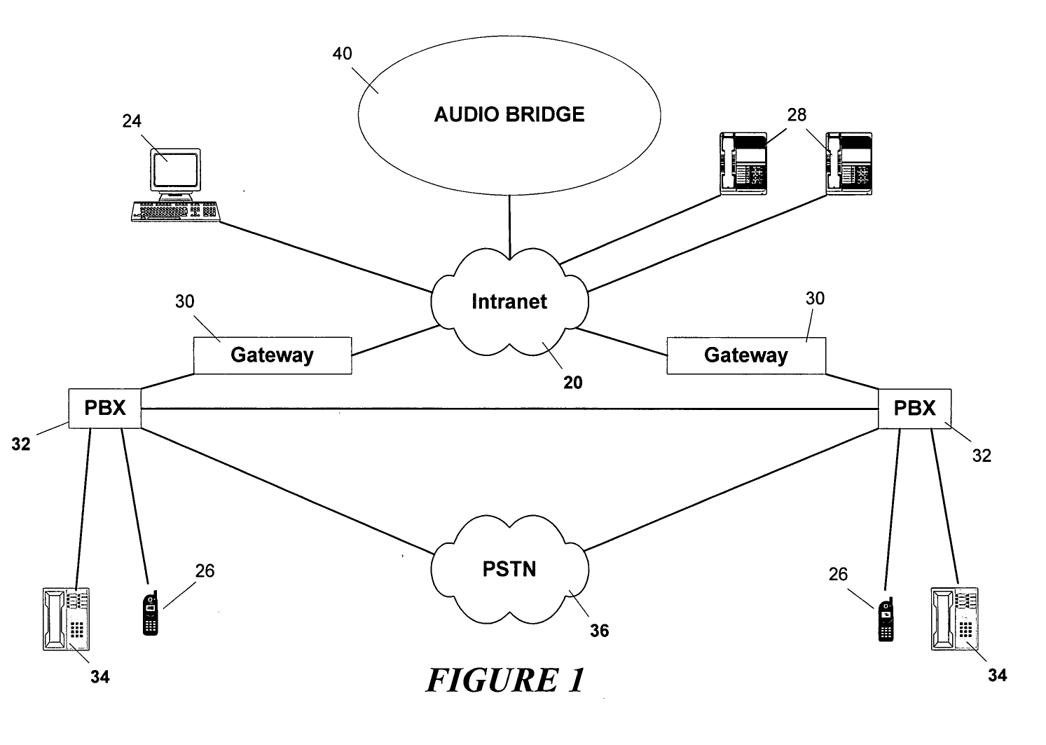

The present invention may be used with a collaboration tool that operates around a general backbone architecture that allows various access points and functionality. Shown in FIG. 1 is a general overview of some of that accessibility. A digital network, such as intranet 20, can serve as the host for the collaboration tool, and a primary connection medium for the system. Operating with the intranet is audio bridge 40, which provides audio interconnection between a variety of different connection points. Such connection points may include workstation 24, which may host a software phone, and IP phones 28, such as model 7960 produced by Cisco Systems, Inc. These different communications points all transmit and receive data via the intranet 20, and allow a user audio access to the collaboration tool. Also connected to the intranet of FIG. 1 are gateways 30, each of which provide connection to private branch exchange (PBX) switches 32 that each service a number of conventional telephone sets 34 or wireless phones (or other wireless audio devices) 26. The PBX switches 32 may also be connected to a public service telephone network (PSTN) 36, which operates according to conventional telephony principles, as well as to each other, if the two switches are part of a common internal switching network. Those skilled in the art will recognize that the various connection points shown in FIG. 1 are for example only, and that numerous different connectivity arrangements are possible.

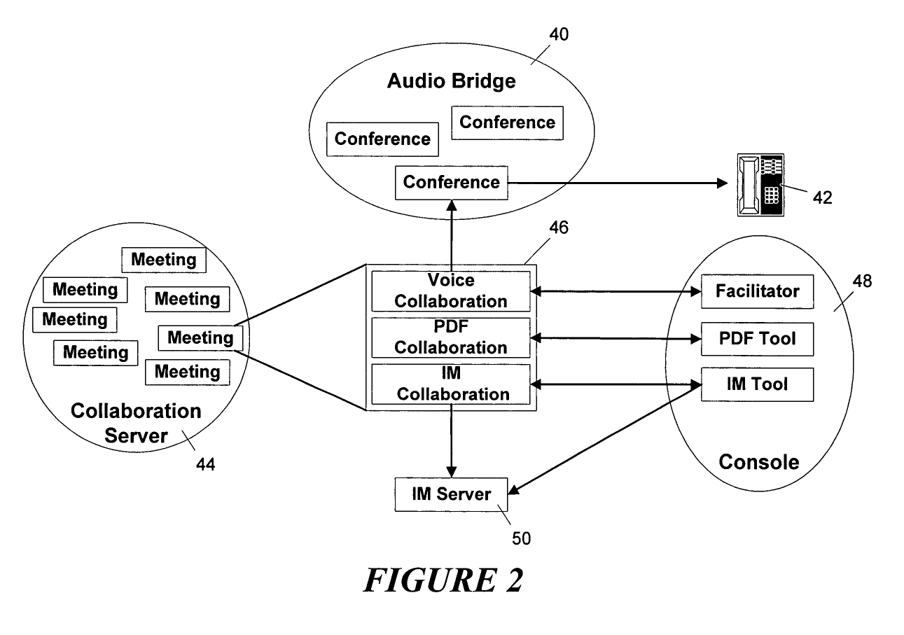

The collaboration tool provides a number of unique functions that simplify and enhance distributed meetings, making them more effective. Several different software components work in concert to provide this functionality, and the illustration of FIG. 2 shows a generalized breakdown of these components. Given that the central communication medium of most meetings is voice, the primary interface of the system is audio bridge 40. The audio bridge is a mixing tool for managing simultaneous streams of packet-switched audio data, and rendering custom mixes of the data streams for each of the users. This custom mixing of the voice data is key to enabling a number of the useful features of the collaboration tool. FIG. 2 demonstrates this capability by the indication of an output from a conference being managed by the audio bridge 40 to a communication device, in this case telephone set 42. Those skilled in the art will recognize that the data may actually pass through other layers and media before reaching the phone set itself. As is also indicated in FIG. 2, the audio bridge is capable of managing the mixing tasks for multiple conferences at the same time.

A collaboration server 44 manages the collaboration functions for each of the meetings making use of the collaboration tools at a given time. For each of these meetings, a collaboration space 46 is established, within which data sharing is provided in different formats (for clarity, only one collaboration space is shown graphically in FIG. 2). A user console 48, available to each user that is connected via an appropriate interface, provides access to many of the features of the collaboration tool. As shown, a facilitator tool provides the user with control over the voice collaboration, a portable document format (PDF) (or other document format) tool provides control over PDF collaboration, and an instant messaging (IM) tool provides control over a IM collaboration, in conjunction with an IM server 50.

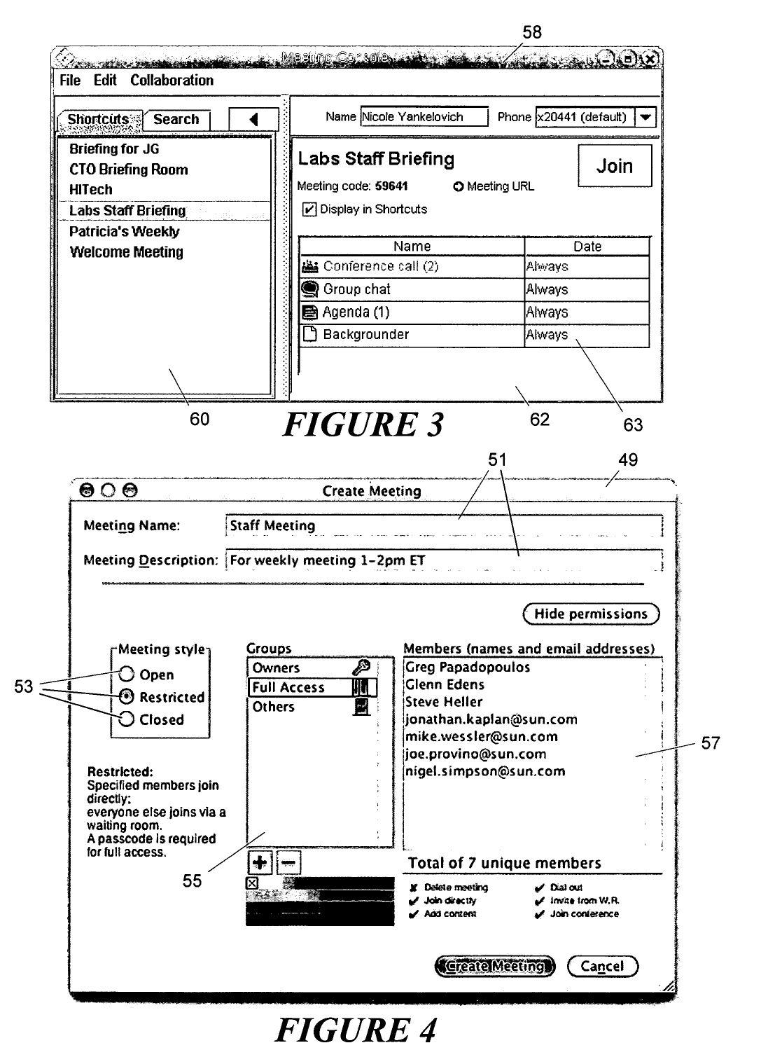

The collaboration tool is preferably based on a graphical user interface (GUI) application accessible by a user of the collaboration tool. The interface makes use of controls and information placed in different windows so as to provide an intuitive look and feel for manipulating the conditions for a particular user. Upon launching the application, and optionally logging in via a login control window, the application presents a “central console” window 58, as shown in FIG. 3. Along the left side of the window is a list (or a subset of a list) 60 of current people and meetings recognized by the collaboration tool. Selection of an item on the list brings up information regarding that item in the information pane 62. When a meeting is highlighted in the list, the user may select from the listed items in the information pane that they would like to join, such as a conference call or a text chat. Highlighting of the items in the information pane and clicking the “join” button connects the user to the meeting in the specified communication mode or modes. If a person is highlighted in the list 60, the pane 62 may bring up information regarding that person, including a radio button that may be clicked to initiate contact with the selected person.

From the console window, it is also possible to create a new meeting. Selecting “create meeting” from the “file” menu brings up a “create meeting” window 49, as shown in FIG. 4. Information spaces 51 show the meeting name and description that are established by the creator of the meeting (also referred to as the “owner”). The “style” of meeting may be selected using radio buttons 53, the options being “open”, “restricted” or “closed.” The selected meeting style affects the access of others to the meeting. In an “open” meeting, anyone else can join the meeting directly. In a “restricted” meeting, people that the owner specifies as having “full access” may join the meeting room directly, but everyone else must enter through a “waiting room” (discussed in more detail below). Finally, a “closed” meeting is closed to everyone except for those people who are specified as having “full access” or “waiting room” access.

The access privileges of other users are established by creating “permissions” for each of the users named by the owner. To the right of the “meeting style” radio buttons is a list of “groups.” Depending on the meeting style selected, different groups will be available. There are several different default groups available. “Owners” include the person who created the meeting room, and other owners may be added to the list. These users are granted all possible permissions to the meeting room, including direct access and the ability to delete the meeting room. “Full access” users have all permissions except for the ability to delete the meeting room. Users with “Waiting Room” access are placed into a waiting room when they join the meeting, and may be invited into the main meeting by someone with full access. “Others” refers to everyone whose name is not specified in any of the other groups. These users have the most restricted permissions and, in restricted meetings, others can only join the conference via the waiting room. In Closed meetings, Others have no permissions and may not join the meeting.

For each of the groups specified, the owner of the meeting enters the identifiers of the users to whom the permissions of that particular group are being extended in the “members” box 57. Once all of the users and their permissions are established, the meeting is created by clicking the “create meeting” button 59. The users and permissions may be modified later by any of the meeting owners by editing the meeting properties using a selection from the “edit” menu of the console window. Once the meeting room is created, other users will see the meeting listed in their console windows, and may join (if they have been granted the proper access).

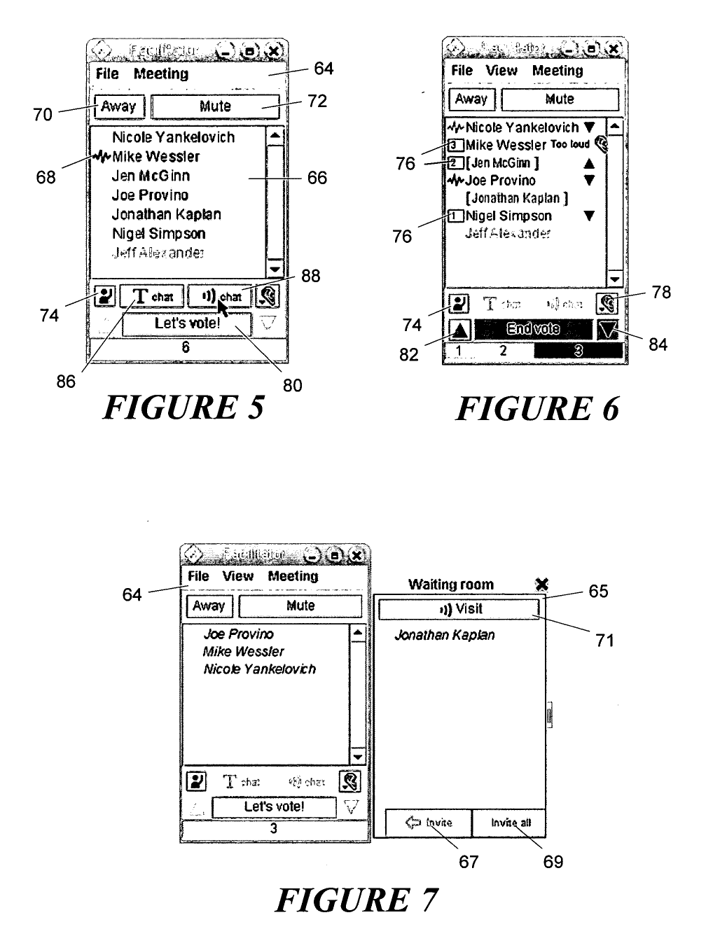

When a user joins a meeting, the application launches a facilitator window 64, an example of which is shown in FIG. 5. A number of features may be accessed through use of the facilitator, many of which are indicated in the figure. The main portion 66 of the facilitator window contains a list of meeting attendees. Those who have joined the meeting are shown in dark text and those who have left are shown in gray. Shown on the facilitator window is a button 70 labeled “away,” which may be clicked by a user when they are going to be temporarily away from the meeting. Clicking this button mutes that person's audio, and causes his or her name to appear in gray on the facilitator windows of all participants.

To indicate which of the participants is speaking at any given time, a speaking indicator 68 appears next to a person's name when the amount of sound on that person's channel is above a given threshold for a given duration. In one embodiment, the darkness with which the speaking indicator is displayed may increase with the time and intensity of the audio detected on that channel, while fading gradually during subsequent periods of quiet. A mute button 72 may also be clicked by a user to mute his or her channel. This helps to minimize extraneous noise being introduced to the meeting over channels of participants who are not speaking for a certain period of time. When a user mutes his or her channel, brackets appear around the name of that person in the facilitator window of all the participants, allowing all to see that that person's audio is muted.

Any participant may speak and be heard at any time, but it may be desirable to implement a policy of requesting that only one participant speak at a time. To aid this, a “hand raise” button 74 is provided. When a person other than the current speaker would like an opportunity to say something, the hand raise button 74 may be clicked on that person's facilitator window. The result is the placement of a numbered icon 76 in the facilitator display of all the meeting participants, as shown in FIG. 6. The number shown in the icon corresponds to the order in which multiple participants may have clicked their respective hand raise icons. This order is represented in the facilitator displays of all of the participants, such that the first one to click has an icon with the number “1” shown next to his or her name, the second has the number “2,” and so on. The use of the hand raise icons allows the current speaker to recognize that someone has a question, without the flow of the conversation being disrupted by a verbal interruption. The numbering of the icons allows the current speaker to know in which order the requests were made. When a user who has selected the hand raise icon, and is waiting to speak no longer wishes to speak, that person clicks the hand raise icon again, and the numbered icon next to his or her name is removed. Any numbered icons with higher numbers correspondingly decrement by one. This may occur if the requester has already spoken, or if the reason for speaking is obviated. In one embodiment, if a person that has used the hand raise icon, and has been speaking for a long time, the system will remove the icon under the premise that this person now “has the floor.”

Another problem that can be addressed non-verbally using the facilitator window is difficulty with the audio on another user's channel. The other user may be speaking too softly or too loudly, or may have background noise or a technical malfunction that makes it difficult or impossible to hear him or her. An audio button 78 is provided on the facilitator window that can be clicked by a user to indicate trouble with the audio channel of another participant. Clicking this button brings up a drop-down menu (not shown). This menu allows the user to select the speaker whose audio is poor, as well as choose from several options that describe the problem.

A voting button 80 on the facilitator allows anyone in the meeting to call for a vote. When the voting button is clicked by a user, two voting arrow buttons 82, 84 are enabled on the facilitator of each participant. The user calling for the vote verbally explains the basis of the vote, and what the selection of the up or down arrow means in the voting process. For example, the current speaker might suggest that the users click the up arrow 82 if they have finished reading a written item being discussed, or to click the down arrow 84 to indicate that more time is needed. Similarly, a vote might be to use the up arrow 82 to agree with a proposed idea, or the down arrow 84 if one disagrees. As shown in FIG. 6, the votes of each participant are displayed next to the participant's name on each user's facilitator. In one embodiment, the arrow buttons are different colors, such as the up arrow 82 being blue and the down arrow 84 being red. Colored bars at the bottom of the window may also be used to indicate the vote tally, the colors of the bars matching the colors of the up or down arrows that they represent. During the voting process, the display on the voting button 80 may change to indicate that a vote has been called. In such a case, the voting button 80, which may have read something like “let's vote” before being clicked initially, may instead read something like “end vote.” Clicking of the button by the user that called the vote will then terminate the voting process, remove the arrow indicators next to the user names, and return the up and down arrow buttons 82, 84 to a disabled state.

Also on the facilitator is a private text chat button 86, shown most clearly in FIG. 5. Each meeting can have one or more group text chats associated with the meeting. The group text chats are identified in the collaboration table 63 of the information pane 62 shown in the central console window 58 (FIG. 3), and are visible by anyone in the meeting who wishes to join them. However, as mentioned above, a private chat window can also be opened by any user. To do this, the names of the participants with whom the chat is to take place are selected, for example by highlighting with a cursor, from the facilitator window 64 (e.g., users “Joe Provino” and “Jonathan Kaplan” in FIG. 5), and the private text chat button 86 is clicked. In one embodiment, double-clicking on a person's name will also open a text chat window shared by the user initiating the chat and the user whose name is clicked. The private text chat sessions will not appear in the meeting's collaboration table 63 since it is private and not available to others to join.

While in a meeting, it is also possible to have a private voice chat with one or more meeting participants without the other participants hearing the voice chat conversation. To initiate a voice chat, one or more names in the facilitator window 64 are highlighted, and the voice chat button 88 (shown most clearly in FIG. 5) is clicked. This opens a voice chat window (not shown) below the facilitator window of each participant to the voice chat. Displayed in the voice chat window are the names of the chat participants. The names of the chat participants also appear bracketed in the facilitator window of all the meeting participants, indicating that their audio inputs to the main meeting have been muted. In an exemplary embodiment, there is no other indication to the other meeting participants that some of the members are engaged in a voice chat, although it might be surmised by the manner in which certain names in the facilitator window change between being bracketed to not bracketed. If desired, a user could mute his or her audio first, and then later join the voice chat, so as not to make it apparent that he or she is participating in the voice chat. Those skilled in the art will recognize that it would be possible to also display to all the users that a voice chat is taking place, if such a feature was desired.

Another feature of the collaboration tool is the ability to invite certain participants to a meeting while providing a way to exclude them from certain portions of the meeting conversation. In the context of the present invention, this feature is referred to as a “waiting room” because it takes the form of a virtual location in which the designated invitees are sequestered while those controlling the meeting determine the appropriate time at which to invite these potential participants to join the meeting.

A waiting room is designed to be used in conjunction with a restricted or closed meeting. The purpose of the waiting room is to prevent people without full access privileges from joining the meeting directly. This is useful when confidential content is being discussed. As newcomers with restricted access join the meeting, they will be placed in the waiting room and will not be able to hear the discussion proceeding in the main meeting. They may, however, be able to communicate with other participants in the waiting room.

In the exemplary embodiment, as soon as a user enters the waiting room, a waiting room window 65 opens next to the facilitator window on the displays of each of the meeting participants. An example of this is shown in FIG. 7. To move from the waiting room into the main meeting, the person in the waiting room must be invited by someone who has full access privileges. The person with full access can either select an individual's name in the waiting room and click on the “Invite” button 67, or can opt to invite all of the users in the waiting room by selecting the “invite all” button 69. Once invited, a user in the waiting room is joined into the main meeting. The “invite all” choice moves everyone currently in the waiting room into the main meeting.

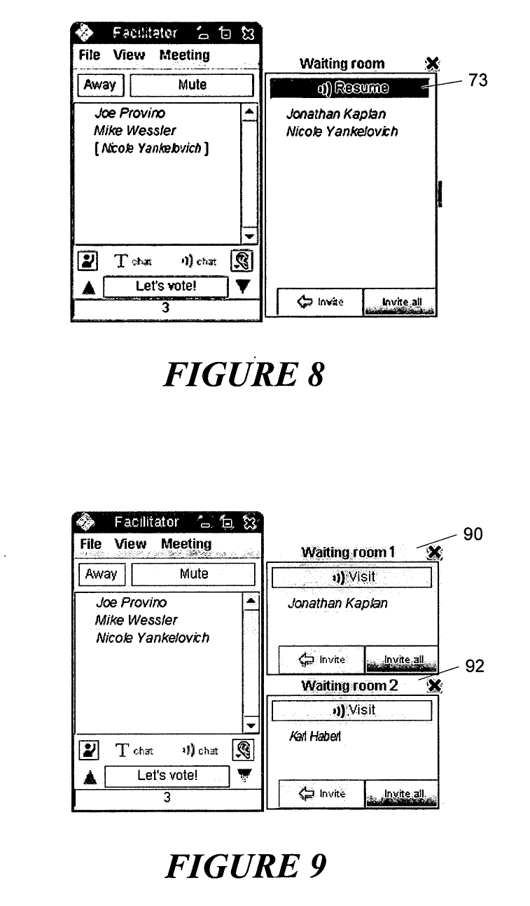

In the example shown in FIG. 7, the names of those in the main meeting are shown in the facilitator window, i.e., “Joe Provino”, “Mike Wessler” and Nicole Yankelovich.” Those users in the waiting room have their name displayed in the waiting room window (“Jonathan Kaplan” in FIG. 7). A participant to the main meeting can also communicate with users in the waiting room by clicking on the “visit” button 71 in his or her waiting room window. Selection of this button moves the user selecting it to the waiting room, which has the effect of muting his or her audio in the main meeting, and causes that person's name and speaking indicator to appear in the waiting room window 65 of all of the participants. This is demonstrated in FIG. 8, in which the user “Nicole Yankelovich” has temporarily left the main meeting to visit the waiting room. To return to the main meeting, the user visiting the waiting room may select the “resume” button 73, which replaces the “visit” button when the user visits the waiting room. When the “resume button” is selected, the user's name is removed from the waiting room, and the user will rejoin the main meeting, and will be “unmuted” in the main meeting if that user was unmuted in the waiting room.

Any participant in the main meeting can also move themselves into the waiting room, perhaps at the request of the meeting leader. To do this, a user selects, from the “Meeting” menu on the facilitator, the “exit to waiting room” command. Unlike visiting, once a user moves into the waiting room, his or her ability to rejoin the main meeting depends on that person's access privileges. If he or she has restricted access, the main meeting may be rejoined only at the invitation of someone with full privileges. Buttons 67 and 69 are disabled for a user with restricted privileges. If a user with full privileges exits to the waiting room, he or she may rejoin the meeting at any time by inviting himself or herself. Those skilled in the art will recognize that, even if a meeting is not restricted, the waiting room may be used for break-out discussions.”

In the present example, a user can hide the waiting room window on his or her display by selecting the “hide waiting room” command from the “View” menu. The “X” in the upper right corner of the waiting room window may also be selected to close it. The waiting room will automatically appear whenever a user enters it, but one can show it manually at any time by selecting the “show waiting room” command from the “View” menu.

As shown in FIG. 9, it is also possible to have multiple waiting rooms such as waiting rooms 90, 92, open at the same time. In such a case, each waiting room serves as a separate group, which may include one or more participants outside of the main meeting. As in the single waiting room example, each of the multiple waiting rooms allow communication between those participants that are part of that waiting room, but excludes those in other waiting rooms. The use of multiple waiting rooms might be useful, for example, to allow separate teams of individuals to have a private discussion forum while waiting to be introduced to the main meeting. It might also be used for multiple breakout sessions when different groups of participants in the main meeting wish to leave temporarily to discuss something amongst themselves.

While the invention has been shown and described with reference to a preferred embodiment thereof, it will be recognized by those skilled in the art that various changes in form and detail may be made herein without departing from the spirit and scope of the invention as defined by the appended claims.

What is claimed is:

1. A network collaboration system for facilitating interaction between network clients having access to a digital network, the system comprising:
a communications tool that accepts audio inputs from network clients, and provides audio outputs to network clients that comprise a mix of said audio inputs;
a network interface that allows network clients to participate in a collaboration in which certain collaborating clients are connected using the communications tool such that audio inputs from the collaborating clients may be mixed together and delivered to the collaborating clients as audio outputs;
a grouping feature by which network clients that are participants in a collaboration are segregated into a plurality of groups, a first group of the participants being in audio communication with each other in a primary audio forum, and a second group of participants being excluded from the primary audio forum such that no audio inputs from participants in the first group are received by any participant in the second group; and
an access tool by which at least one participant of the first group can identify the participants in each of the first and second groups and selectively grant access to any designated participants of the second group that allows the designated participants to join the first group.

2. A system according to claim 1 wherein each of the participants has a set of access privileges that establishes that participant's ability to join the first group.

3. A system according to claim 2 wherein the network interface includes a meeting creation tool that allows a network client to create a virtual meeting space by which the participants to a collaboration are selected, and wherein the access privileges of the participants are granted by the network client that creates the virtual meeting space.

4. A system according to claim 3 further comprising a function that allows participants of the first group to leave the first group and join the second group.

5. A system according to claim 4 wherein the ability of a participant that leaves the first group and joins the second group to rejoin the first group depends on the access privileges of that participant.

6. A system according to claim 1 wherein the second group is one of a plurality of secondary groups that may exist simultaneously with the first group and with each other, and wherein the participants of each of the secondary groups are excluded from the primary audio forum and from each other, such that no audio inputs from participants in the first group are received by any participant in a secondary group, and no audio inputs from participants in a secondary group are received by any participant in any of the other secondary groups.

7. A system according to claim 3 wherein the ability of a first participant to grant access to designated participants of the second group that allows the designated participants to join the first group depends on the access privileges of the first participant.

8. A method for facilitating collaboration between network clients having access to a digital network, the system comprising:
providing a communications tool that accepts audio inputs from network clients, and provides audio outputs to network clients that comprise a mix of said audio inputs;
providing a network interface that allows network clients to participate in a collaboration in which certain collaborating clients are connected using the audio communications tool such that audio inputs from the collaborating clients may be mixed together and delivered to the collaborating clients as audio outputs;
grouping the network clients that are participants in a collaboration such that the participants are segregated into a plurality of groups, a first group of the participants being in audio communication with each other in a primary audio forum, and a second group of participants being excluded from the primary audio forum such that no audio inputs from participants in the first group are received by any participant in the second group; and
providing access control to at least one participant of the first group that allows said participant to identify the participants in each of the first and second groups and selectively grant access to any designated participants of the second group that allows the designated participants to join the first group.

9. A method according to claim 8 wherein each of the participants has a set of access privileges that establishes that participant's ability to join the first group.

10. A method according to claim 9 wherein the network interface includes a meeting creation tool that allows a network client to create a virtual meeting space by which the participants to a collaboration are selected, and wherein the access privileges of the participants are granted by the network client that creates the virtual meeting space.

11. A method according to claim 10 further comprising allowing participants of the first group to leave the first group and join the second group.

12. A method according to claim 11 wherein the ability of a participant that leaves the first group and joins the second group to rejoin the first group depends on the access privileges of that participant.

13. A method according to claim 8 wherein the second group is one of a plurality of secondary groups that may exist simultaneously with the first group and with each other, and wherein the participants of each of the secondary groups are excluded from the primary audio forum and from each other, such that no audio inputs from participants in the first group are received by any participant in a secondary group, and no audio inputs from participants in a secondary group are received by any participant in any of the other secondary groups.

14. A method according to claim 10 wherein the ability of a first participant to grant access to designated participants of the second group that allows the designated participants to join the first group depends on the access privileges of the first participant.

15. A network collaboration system for facilitating interaction between network clients having access to a digital network, the system comprising:
means for accepting audio inputs from network clients, and providing audio outputs to network clients that comprise a mix of said audio inputs;
means for enabling network clients to participate in a collaboration in which certain collaborating clients are connected using the audio communications tool such that audio inputs from the collaborating clients may be mixed together and delivered to the collaborating clients as audio outputs;
means for grouping together network clients that are participants in a collaboration such that they are segregated into a plurality of groups, a first group of the participants being in audio communication with each other in a primary audio forum, and a second group of participants being excluded from the primary audio forum such that no audio inputs from participants in the first group are received by any participant in the second group; and
means for enabling at least one participant of the first group to identify the participants in each of the first and second groups and selectively grant access to any designated participants of the second group that allows the designated participants to join the first group.

16. A system according to claim 15 wherein each of the participants has a set of access privileges that establishes that participant's ability to join the first group.

17. A system according to claim 16 wherein the means for enabling network clients to participate in a collaboration includes means for enabling a network client to create a virtual meeting space by which the participants to a collaboration are selected, and wherein the access privileges of the participants are granted by the network client that creates the virtual meeting space.

18. A system according to claim 17 further comprising means for enabling participants of the first group to exit the first group and join the second group.

19. A system according to claim 15 wherein the second group is one of a plurality of secondary groups that may exist simultaneously with the first group and with each other, and wherein the participants of each of the secondary groups are excluded from the primary audio forum and from each other, such that no audio inputs from participants in the first group are received by any participant in a secondary group, and no audio inputs from participants in a secondary group are received by any participant in any of the other secondary groups.

20. A system according to claim 17 wherein the ability of a first participant to grant access to designated participants of the second group that allows the designated participants to join the first group depends on the access privileges of the first participant.
